(19) United States
(12) Patent Application Publication
(10) Pub. No.: US 2024/0227622 A9
(43) Pub. Date: Jul. 11, 2024

(54) Vehicle Battery Charging System and Battery Charging Method Thereof

(71) Applicants: Hyundai Motor Company, Seoul (KR); Kia Corporation, Seoul (KR)

(72) Inventor: Min Seong Choi, Hwaseong-si (KR)

(21) Appl. No.: 18/178,069

(22) Filed: Mar. 3, 2023

(30) Foreign Application Priority Data
Oct. 24, 2022 (KR) 10-2022-0137542

(51) Int. Cl. B60L 58/18; B60L 53/20

(52) U.S. Cl. CPC B60L 58/18; B60L 53/20; B60L 2210/30; B60L 2240/547

(57) ABSTRACT

The present disclosure relates to a vehicle battery charging system and a battery charging method thereof. The present disclosure provides a battery charging method of a battery charging system including an on-board charger to convert an AC voltage from an outside into a DC voltage, a first battery, and a second battery having a lower rated voltage than that of the first battery, the battery charging method including: operating a first charging mode of turning on a first switch between the on-board charger and the first battery and turning off a second switch between the on-board charger and the second battery when a voltage of the second battery exceeds a first threshold value; and operating a second charging mode of turning off the first switch and turning on the second switch when the voltage of the second battery does not exceed the first threshold value.

### CROSS-REFERENCE TO RELATED APPLICATION(S)

This application is based on and claims priority under 35 U.S.C. 119 to Korean Patent Application No. 10-2022-0137542, filed on Oct. 24, 2022, in the Korean Intellectual Property Office, the disclosure of which is herein incorporated by reference in its entirety.

### TECHNICAL FIELD

The present disclosure relates to a vehicle battery charging system and, more particularly, to a vehicle battery charging system for converting power for battery charging by using an on-board charger (OBC) and a battery charging method thereof.

### BACKGROUND

With growing concern about the environment in recent years, eco-friendly vehicles having an electric motor as a power source are on the increase. An eco-friendly vehicle is also called an electric-motor vehicle, and representative examples may include a hybrid electric vehicle (HEV) and an electric vehicle (EV).

Generally, for small or light electric vehicles, cost competitiveness is most important, and cost reduction in power electronic (PE) components as well as a high-voltage battery is very important. Among high-voltage PE components, a high-voltage battery is the most expensive component, and the capacity of a high-voltage battery needs to be minimized to reduce costs for PE components. However, when the capacity of a high-voltage battery is reduced, the mileage of a vehicle is reduced, and the output of a motor and an inverter is also reduced.

Recently, to minimize the price of an electric vehicle, research for reducing a battery capacity and reducing a voltage has been conducted. Further, an electric vehicle configured with a 48-V system is also currently being developed to minimize the price of a vehicle.

A 48-V main battery may be used to charge a 12-V auxiliary battery for driving an electrical load. To this end, the voltage of the main battery needs to be converted into the voltage of the auxiliary battery by using a low-voltage DC-DC converter (LDC). However, the charging efficiency of the auxiliary battery is reduced as an AC voltage passes through an OBC and the LDC.

Accordingly, a vehicle battery charging system with improved charging efficiency is required in this technical field.

### SUMMARY

A technical aspect of the present disclosure is to provide a vehicle battery charging system with improved charging efficiency and a battery charging method thereof.

Another technical aspect of the present disclosure is to provide a vehicle battery charging system capable of minimizing power loss when charging an auxiliary battery by using an external AC power source and a battery charging method thereof.

Still another technical aspect of the present disclosure is to provide a vehicle battery charging system capable of efficiently managing charging of a main battery and an auxiliary battery and a battery charging method thereof.

The technical subjects pursued in the present disclosure may not be limited to the above-mentioned technical subjects, and other technical subjects which are not mentioned may be clearly understood, through the following descriptions, by those skilled in the art to which the present disclosure pertains.

In view of the foregoing aspects, a battery charging method of a battery charging system including an on-board charger to convert an AC voltage from an outside into a DC voltage, a first battery, and a second battery having a lower rated voltage than that of the first battery according to an embodiment of the present disclosure may include operating a first charging mode of turning on a first switch between the on-board charger and the first battery and turning off a second switch between the on-board charger and the second battery when a voltage of the second battery exceeds a first threshold value, and operating a second charging mode of turning off the first switch and turning on the second switch when the voltage of the second battery does not exceed the first threshold value.

The operating of the second charging mode may include determining whether the voltage of the second battery exceeds a second threshold value, and switching the second charging mode to the first charging mode when the voltage of the second battery exceeds the second threshold value.

The operating of the second charging mode may further include maintaining the second charging mode when the voltage of the second battery does not exceed the second threshold value.

The operating of the first charging mode may further include determining whether a voltage of the first battery exceeds a third threshold value, and terminating charging when the voltage of the first battery exceeds the third threshold value.

The operating of the first charging mode may further include determining whether the voltage of the second battery exceeds the first threshold value when the voltage of the first battery does not exceed the third threshold value, and switching to the first charging mode or maintaining the second charging mode according to a result of comparing the voltage of the second battery with the first threshold value.

The battery charging method may further include determining whether the voltage of the second battery exceeds a fourth threshold value, and operating a third charging mode of simultaneously charging the first battery and the second battery when the voltage of the second battery does not exceed the fourth threshold value, before determining whether the voltage of the second battery exceeds the first threshold value.

The third charging mode may simultaneously charge the first battery and the second battery by controlling a first duty ratio, which is a duty ratio of a primary switch of a DC converter of the on-board charger, and a second duty ratio, which is a duty ratio between the first switch and the second switch.

The battery charging method may further include determining whether the voltage of the second battery exceeds the first threshold value when the voltage of the second battery exceeds the fourth threshold value, and operating the first charging mode or the second charging mode according to a result of comparing the voltage of the second battery with the first threshold value.

The first battery and the second battery may mutually share earthing.

The second threshold value may be greater than the first threshold value, and the fourth threshold value may be smaller than the first threshold value.

A battery charging system according to an embodiment of the present disclosure may include an on-board charger to convert an AC voltage from an outside into a DC voltage, a first battery, a second battery having a lower rated voltage than that of the first battery, a first switch between the on-board charger and the first battery, a second switch between the on-board charger and the second battery, and a controller to operate a first charging mode of turning on the first switch and turning off the second switch when a voltage of the second battery exceeds a first threshold value and to operate a second charging mode of turning off the first switch and turning on the second switch when the voltage of the second battery does not exceed the first threshold value.

In the second charging mode, the controller may determine whether the voltage of the second battery exceeds a second threshold value, and may switch to the first charging mode when the voltage of the second battery exceeds the second threshold value.

In the second charging mode, the controller may maintain the second charging mode when the voltage of the second battery does not exceed the second threshold value.

In the first charging mode, the controller may determine whether a voltage of the first battery exceeds a third threshold value, and may terminate charging when the voltage of the first battery exceeds the third threshold value.

In the first charging mode, the controller may determine whether the voltage of the second battery exceeds the first threshold value when the voltage of the first battery does not exceed the third threshold value, and may switch to the first charging mode or maintaining the second charging mode according to a result of comparing the voltage of the second battery with the first threshold value.

Before determining whether the voltage of the second battery exceeds the first threshold value, the controller may determine whether the voltage of the second battery exceeds a fourth threshold value, and may operate a third charging mode of simultaneously charging the first battery and the second battery when the voltage of the second battery does not exceed the fourth threshold value.

In the third charging mode, the controller may simultaneously charge the first battery and the second battery by controlling a first duty ratio, which is a duty ratio of a primary switch of a DC converter of the on-board charger, and a second duty ratio, which is a duty ratio between the first switch and the second switch.

The controller may determine whether the voltage of the second battery exceeds the first threshold value when the voltage of the second battery exceeds the fourth threshold value, and may operate the first charging mode or the second charging mode according to a result of comparing the voltage of the second battery with the first threshold value.

The first battery and the second battery may mutually share earthing.

The second threshold value may be greater than the first threshold value, and the fourth threshold value may be smaller than the first threshold value.

According to various embodiments of the present disclosure described above, a switch or a relay may be added to an output terminal of an existing OBC circuit, thereby charging a main battery and an auxiliary battery only with an OBC without operating an LDC when performing a slow charging operation of an eco-friendly vehicle using a 48-V battery voltage as a main battery

Further, the auxiliary battery may be charged without using the LDC, thereby improving system charging efficiency and reducing a charging time.

Moreover, the auxiliary battery may be charged with higher output power and efficiency than when using a conventional LDC.

In addition, energy efficiency of the vehicle may be improved, and a charging cost of the eco-friendly vehicle may be reduced.

Advantageous effects obtainable from the present disclosure may not be limited to the above mentioned effects, and other effects which are not mentioned may be clearly understood, through the following descriptions, by those skilled in the art to which the present disclosure pertains.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram illustrating the structure of a general vehicle battery charging system;

FIG. 2 is a block diagram illustrating the structure of a vehicle battery charging system according to an embodiment of the present disclosure;

FIG. 3 is a flowchart illustrating a battery charging method according to an embodiment of the present disclosure;

FIG. 4 is a flowchart illustrating a vehicle battery charging method according to another embodiment of the present disclosure;

FIG. 5 illustrates an example of a circuit diagram used to perform a simulation on the basis of the vehicle battery charging method of FIG. 4;

FIG. 6A to FIG. 6F illustrate an example of a result of a simulation performed using the circuit diagram of FIG. 5;

FIG. 7A to FIG. 7F illustrate another example of a result of a simulation performed using the circuit diagram of FIG. 5; and

FIG. 8 is a flowchart illustrating a vehicle battery charging method according to still another embodiment of the present disclosure.

### DETAILED DESCRIPTION

Hereinafter, embodiments disclosed in the present specification will be described in detail with reference to the accompanying drawings, and the same or similar elements are given the same and similar reference numerals, so duplicate descriptions thereof will be omitted. The terms “module” and “unit” used for the elements in the following description are given or interchangeably used in consideration of only the ease of writing the specification, and do not have distinct meanings or roles by themselves. In describing the embodiments disclosed in the present specification, when the detailed description of the relevant known technology is determined to unnecessarily obscure the gist of the present disclosure, the detailed description may be omitted. Further, the accompanying drawings are provided only for easy understanding of the embodiments disclosed in the present specification, and the technical spirit disclosed herein is not limited to the accompanying drawings, and it should be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for the purpose of distinguishing one element from another element.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

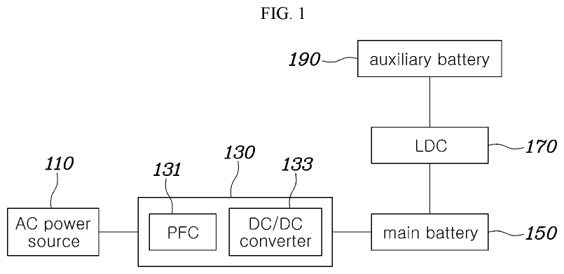

FIG. 1 is a block diagram illustrating the structure of a general vehicle battery charging system.

Referring to FIG. 1, the general vehicle battery charging system includes an AC power source 110, an on-board charger 130, a main battery 150, an LDC 170, and an auxiliary battery 190.

Power from the AC power source 110 is applied to the on-board charger 130 to charge the main battery 150 or the auxiliary battery 190. The AC power source 110 may be a power source installed in an external charging system.

The AC power source 110 may be configured as a commonly used AC power source 110 having different standards by country. Generally, the AC power source 110 may be configured as a commonly used AC power source 110 having a standard of 230 VAC/50 Hz in Europe, 240 VAC/60 Hz in North America, and 220 VAC/60 Hz in Korea.

The on-board charger 130 is provided with AC power from the AC power source 110, and converts the AC power into DC power to charge the main battery 150 or the auxiliary battery 190.

The on-board charger 130 includes a power factor corrector (PFC) 131 and a DC/DC converter 133.

The on-board charger 130 may have a power capacity of, for example, 3.7 kW, 7.2 kW, or 11 kW. When the main battery 150 has a small capacity, the on-board charger 130 of 3.7 kW or 7.2 kW may generally be used.

The PFC 131 converts AC power input from the AC power source 110 into DC power, and improves a power factor.

The DC/DC converter 133 converts the voltage of DC power converted by the PFC 131 into a voltage for charging the main battery 150 or the auxiliary battery 190.

The main battery 150 supplies power for driving a motor of a vehicle.

The main battery 150 may be a battery having a voltage standard of 160 V to 250 V in a case of a hybrid electric vehicle (HEV), and may be a battery having a voltage standard of 400 V to 800 V in a case of a battery electric vehicle (BEV). In some eco-friendly vehicle systems, the main battery 150 may be a battery having a voltage standard of 48 V, and the main battery 150 and the auxiliary battery 190 may share earthing with each other.

The low-voltage DC-DC converter (LDC) 170 converts a voltage from the main battery 150 into a voltage for charging the auxiliary battery 190.

The LDC 170 may have a power standard of, for example, 1.5 kW to 2 kW.

The auxiliary battery 190 supplies power for driving an electrical load of the vehicle.

Here, the auxiliary battery 190 may have a voltage of 12 V.

In the vehicle battery charging system, when the main battery 150 has a high voltage of 100 V or more, the LDC 170 necessarily requires insulation, and accordingly the ground of the main battery 150 and the ground of the auxiliary battery 190 are separated from each other.

However, in an eco-friendly vehicle system in which the main battery 150 has a voltage of 48 V, insulation between the main battery 150 and the auxiliary battery 190 is not necessarily required, and thus the LDC 170 may be designed as a buck converter with a simple configuration.

In the vehicle battery charging system, the on-board charger 130 generally charges only the main battery 150, and needs to convert power of the main battery 140 through the LDC 170 in order to charge the auxiliary battery 190. When the on-board charger 130 of, for example, 3.7 kW, 7.2 kW, or 11 kW is used, the on-board charger 130 may convert a voltage with an efficiency of about 95%. In addition, when the LDC 170 of, for example, 1.5 kW to 2 kW is used, the LDC 170 may convert a voltage with an efficiency of about 90%. However, when the main battery 150 does not require insulation of the LDC 170 and has an insignificant difference between an input voltage and an output voltage as in the eco-friendly vehicle system in which the main battery 150 has a 48 V voltage, the LDC 170 may convert a voltage with an efficiency of about 95%. Therefore, when charging the auxiliary battery 190 via the on-board charger 130 and the LDC 170, power from the AC power source 110 enables the auxiliary battery 190 to be charged with an efficiency of about 85% to 90%.

However, when the main battery or the auxiliary battery is charged by converting power from the AC power with the on-board charger without using a separate LDC, the battery may be charged with an efficiency of about 95%. In addition, since a power capacity used for charging the auxiliary battery is also increased from an existing LDC capacity of 1.5 kW to 2 kW to an OBC capacity of 3.7 kW or 7.2 kW, a charging time required to charge the auxiliary battery and energy efficiency may be improved.

Hereinafter, a battery charging system and a battery charging method capable of charging a main battery or an auxiliary battery by converting power from an AC power source with an on-board charger without using a separate LDC will be described.

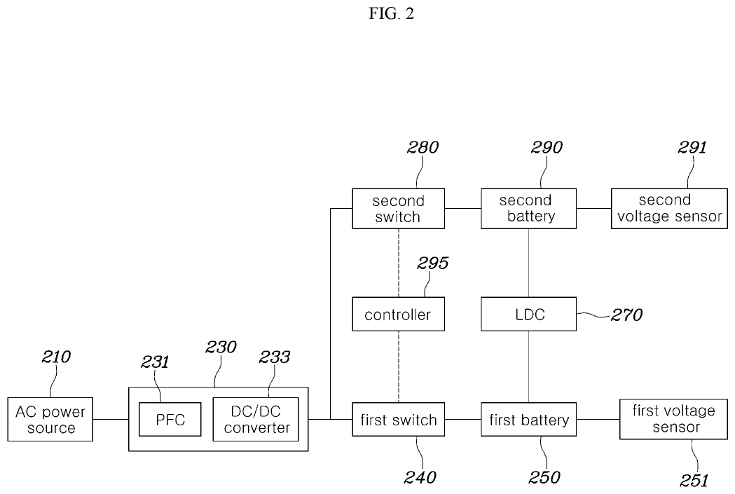

FIG. 2 is a block diagram illustrating the structure of a vehicle battery charging system according to an embodiment of the present disclosure.

Referring to FIG. 2, the vehicle battery charging system according to the embodiment includes an AC power source 210, an on-board charger (OBC) 230, a first switch 240, a first battery 250, an LDC 270, a second switch 280, a second battery 290, and a controller 295.

Power from the AC power source 210 is applied to the OBC 230 to charge the first battery 250 or the second battery 290. The AC power source 210 may be a power source installed in an external charging system.

The AC power source 210 may be configured as a commonly used AC power source 210 having different standards by country. Generally, the AC power source 210 may be configured as a commonly used AC power source 210 having a standard of 230 VAC/50 Hz in Europe, 240 VAC/60 Hz in North America, and 220 VAC/60 Hz in Korea.

The OBC 230 is provided with AC power from the AC power source 210, and converts the AC power into DC power to charge the first battery 250 or the second battery 290.

The OBC 230 includes a power factor corrector (PFC) 231 and a DC/DC converter 233.

The OBC 230 may have a power capacity of, for example, 3.7 kW, 7.2 kW, or 11 kW. When the first battery 250 and the second battery 290 have a small capacity, the OBC 230 of 3.7 kW or 7.2 kW may generally be used.

The PFC 231 converts AC power input from the AC power source 210 into DC power, and improves a power factor.

The DC/DC converter 233 converts the voltage of DC power converted by the PFC 231 into a voltage for charging the first battery 250 or the second battery 290.

The DC/DC converter 233 may include a primary coil and a secondary coil, and at least one switch may be included in an input terminal of the primary coil.

An input signal of the primary coil of the DC/DC converter 233 may be controlled by turning on/off the at least one switch.

The DC/DC converter 233 may adjust the turns ratio between the primary coil and the secondary coil and the duty ratio of the at least one switch included in the input terminal of the primary coil, thereby simultaneously charging the first battery 250 or the second battery 290 under various conditions.

For example, the DC/DC converter 233 may periodically repeat an operation of outputting a voltage for charging the first battery 250 for a predetermined time and outputting a voltage for charging the second battery 290 for a predetermined time.

The first switch 240 connects or blocks a power supply path for charging the first battery 250 from the OBC 230.

The first battery 250 is charged with power supplied from the AC power source 210 and converted by the OBC 230, and supplies power for driving a motor of a vehicle.

The first battery 250 may be a battery having a voltage standard of 48 V.

The low-voltage DC-DC converter (LDC) 270 converts a voltage from the first battery 250 into a voltage for charging the second battery 290.

The LDC 270 may be configured to stop operating when the vehicle receives power from the AC power source 210, and to resume operating only when the second battery 290 needs charging from the first battery 250 while the vehicle is driving.

The LDC 270 may have a power standard of, for example, 1.5 kW to 2 kW.

The second switch 280 connects or blocks a power supply path for charging the second battery 290 from the OBC 230.

The second battery 290 supplies power for driving an electrical load of the vehicle.

The second battery 290 may be a battery having a voltage standard of 12 V.

The first battery 250 and the second battery 290 may share earthing with each other.

A first voltage sensor 251 and a second voltage sensor 291 measure the voltage of the first battery 250 and the voltage of the second battery 290, respectively.

The controller 295 controls the first switch 240 and the second switch 280 to be on/off, thereby controlling charging of the first battery 250 and the second battery 290.

In a conventional vehicle battery charging system, to charge the second battery 290, power from the AC power source 210 may pass through the OBC 230, the first battery 250, and the LDC 270, thereby charging the second battery 290. However, in the vehicle battery charging system according to the present embodiment, the power from the AC power source 210 may pass through the OBC 230 and the second switch 280 without going through the LDC 270, thereby charging the second battery 290.

Accordingly, in the conventional vehicle battery charging system, power loss occurs in the OBC 230 and the LDC 270 while the second battery 290 is charged from the AC power source 210. However, in the vehicle battery charging system according to the present embodiment, power loss occurs only in the OBC 230 while the second battery 290 is charged from the AC power source 210, thus increasing system charging efficiency.

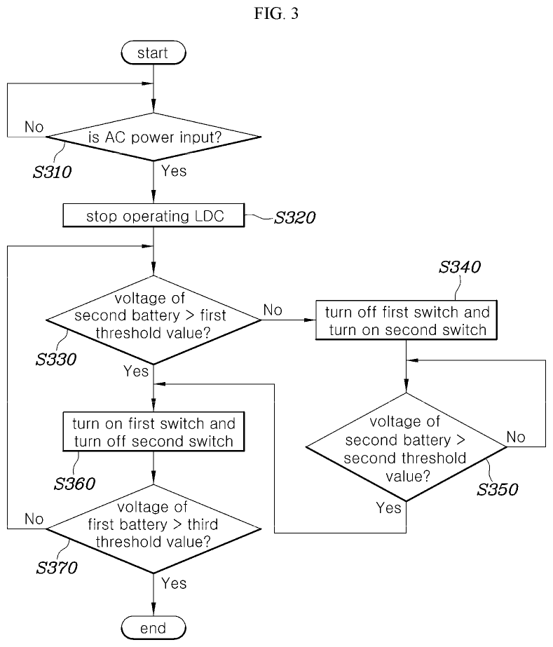

FIG. 3 is a flowchart illustrating a battery charging method of a vehicle battery charging system according to an embodiment of the present disclosure. Operations of the battery charging method according to the present embodiment may be performed by the controller 295.

The controller 295 may monitor whether power from the AC power source 210 is input to the OBC 230, and may control the LDC 270 to stop operating when the power from the AC power source 210 is input to the OBC 230.

The controller 295 determines whether the voltage of the second battery 290 exceeds a first threshold value (S330), and turns off the first switch and turns on the second switch (S340) when the voltage of the second battery 290 does not exceed the first threshold value.

The first threshold value may be variously set according to a system configuration. For example, the first threshold value may be set to 11 V.

Operations S330 and S340 are for determining whether the state of charge (SOC) of the second battery 290 is sufficient, and for blocking charging of the first battery 250 by the OBC 230 and charging the second battery 290 when the SOC of the second battery 290 is not sufficient.

After operation S340 is performed, the controller 295 determines whether the voltage of the second battery 290 exceeds a second threshold value (S350), and turns on the first switch and turns off the second switch (S360) when the voltage of the second battery 290 exceeds the second threshold value.

The second threshold value may be greater than the first threshold value.

The second threshold value may be variously set according to a system configuration. For example, the second threshold value may be set to 15 V.

As a result of determination in operation S350, when the voltage of the second battery 290 does not exceed the second threshold value, the controller 295 controls the second battery 290 to be continuously charged until the voltage of the second battery 290 exceeds the second threshold value.

As a result of determination in operation S330, when the voltage of the second battery 290 exceeds the first threshold value, the controller 295 turns on the first switch and turns off the second switch (S360).

The controller 295 determines whether the voltage of the first battery 250 exceeds a third threshold value (S370), and terminates charging the battery when the voltage of the first battery 250 exceeds the third threshold value.

The third threshold value may be a threshold voltage for determining whether the first battery 250 is fully charged. For example, the third threshold value may be 50 V.

As a result of determination in operation S370, when the voltage of the first battery 250 does not exceed the third threshold value, the controller 295 performs operation S330 again, and performs a subsequent operation according to the result of the determination in operation S330.

An operation of charging the first battery 250 by turning on the first switch 240 and turning off the second switch 280 may be defined as a first charging mode, and an operation of charging the second battery 290 by turning off the first switch 240 and turning on the second switch 280 may be defined as a second charging mode. Thus, according to the present embodiment, the first or second battery may be selectively charged by switching the first and second charging modes according to a result of comparing the voltage of the first or second battery with each threshold value.

According to the present embodiment, the power input from the AC power source 210 may charge the second battery 290 without going through the LDC 270, thereby increasing charging efficiency. For example, assuming that the power from the AC power source 210 is limited to 7.2 kW and the required charging amounts of the first battery 250 and the second battery 290 are 15 kWh and 2 kWh, respectively, the amount of energy required to charge the second battery 290 by using the conventional LDC 270 is (required energy amount of first battery 250/charging efficiency of OBC 230)+(required energy amount of second battery 290/charging efficiency of OBC 230/charging efficiency of LDC 270).

For example, assuming that the charging efficiency of the OBC 230 and the charging efficiency of the LDC 270 are 95%, the amount of energy required to charge the first and second batteries 250 and 290 in the conventional charging system is (15/95)%+2/95%/95%)=15.79+2.22=18.01 kWh.

In the present embodiment, the amount of energy required to charge the first and second batteries 250 and 290 is (required energy amount of first battery 250+required energy amount of second battery 290)/charging efficiency of OBC 230=(15+2)/95%=17.89 kWh.

That is, the charging efficiency and the required charging time of the conventional charging system are 93.77% and 2.52 h, respectively, whereas the charging efficiency and the required charging time of the present embodiment are 95% and 2.49 h, respectively.

Accordingly, compared to the conventional battery charging system, the present embodiment may improve battery charging efficiency and may reduce a charging time.

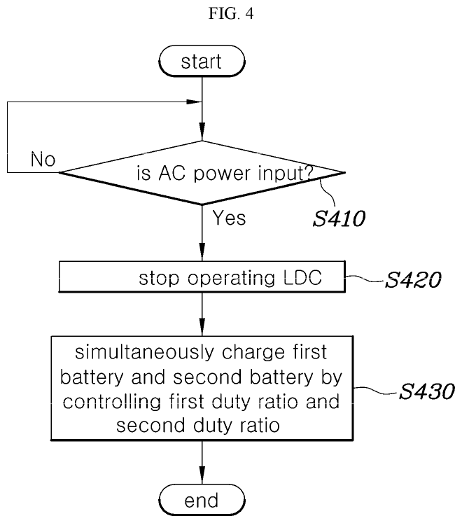

FIG. 4 is a flowchart illustrating a vehicle battery charging method according to another embodiment of the present disclosure. Operations of the battery charging method according to the present embodiment may be performed by the controller 295.

Referring to FIG. 4, the vehicle battery charging system monitors whether power from the AC power source 210 is input to the OBC 230 (S410), and stops operating the LDC 270 (S420) when the power from the AC power source 210 is input.

The controller 295 controls a first duty ratio, which is the duty ratio of the at least one switch connected to the input terminal of the primary coil of the DC/DC converter 233, and a second duty ratio, which is a duty ratio between the first switch 240 and the second switch 280, thereby simultaneously charging the first battery 250 and the second battery 290 (S430).

The first switch 240 and the second switch 280 may be alternately turned on/off, and thus the sum of the duty ratio of the first switch 240 and the duty ratio of the second switch 280 may be 1.

According to the present embodiment, the power input from the AC power source 210 may charge the second battery 290 without going through the LDC 270, thereby increasing charging efficiency. For example, assuming that the power from the AC power source 210 is limited to 7.2 kW and the required charging amounts of the first battery 250 and the second battery 290 are 15 kWh and 2 kWh, respectively, the amount of energy required to charge the second battery 290 by using the conventional LDC 270 is (required energy amount of first battery 250/charging efficiency of OBC 230)+(required energy amount of second battery 290/charging efficiency of OBC 230/charging efficiency of LDC 270).

For example, assuming that the charging efficiency of the OBC 230 and the charging efficiency of the LDC 270 are 95%, the amount of energy required to charge the first and second batteries 250 and 290 in the conventional charging system is (15/95)%+2/95%/95%)=15.79+2.22=18.01 kWh.

In the present embodiment, the amount of energy required to charge the first and second batteries 250 and 290 is (required energy amount of first battery 250+required energy amount of second battery 290)/charging efficiency of OBC 230=(15+2)/95%=17.89 kWh.

That is, the charging efficiency and the required charging time of the conventional charging system are 93.77% and 2.52 h, respectively, whereas the charging efficiency and the required charging time of the present embodiment are 95% and 2.49 h, respectively.

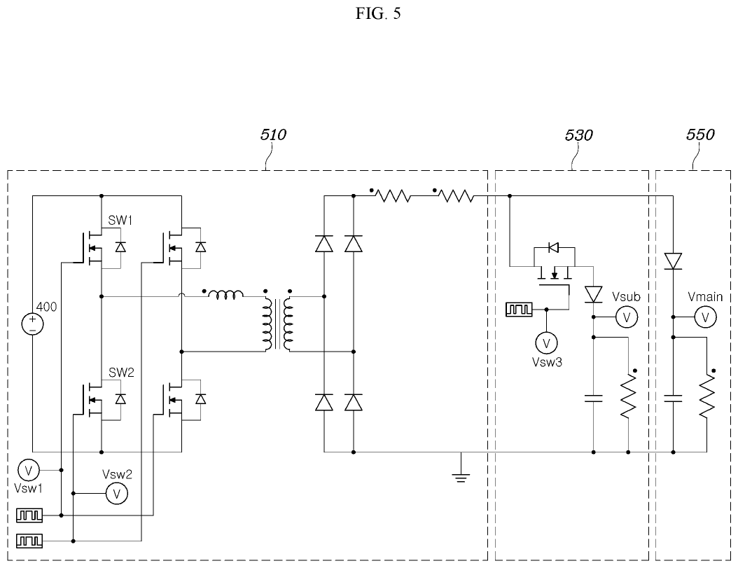

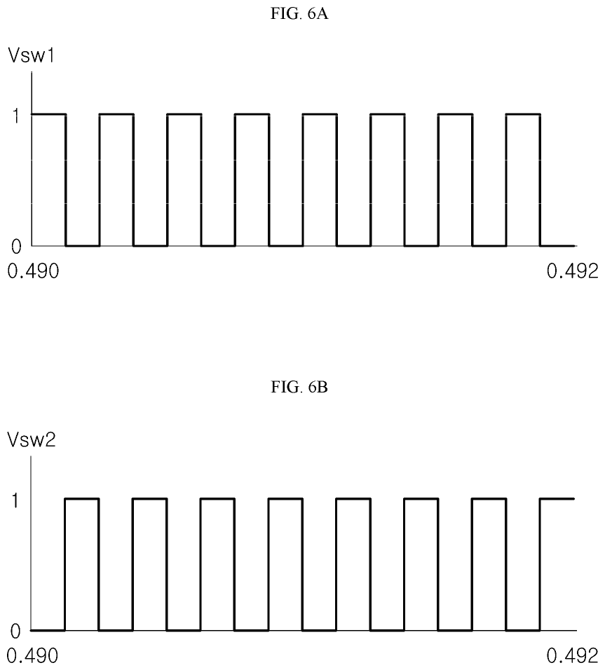

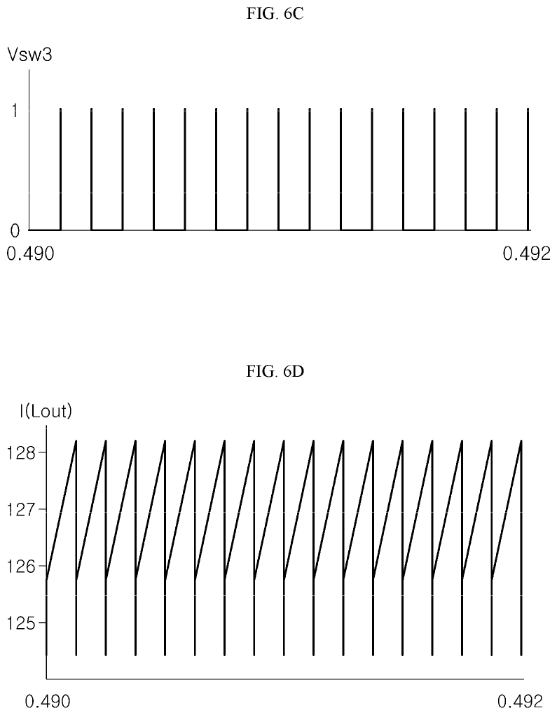

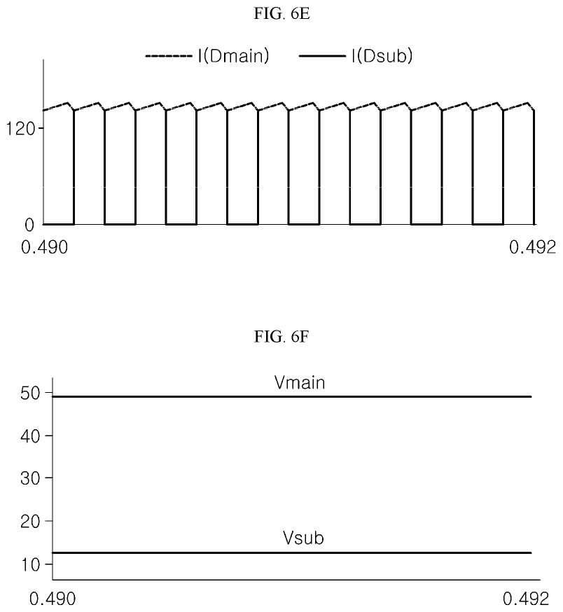

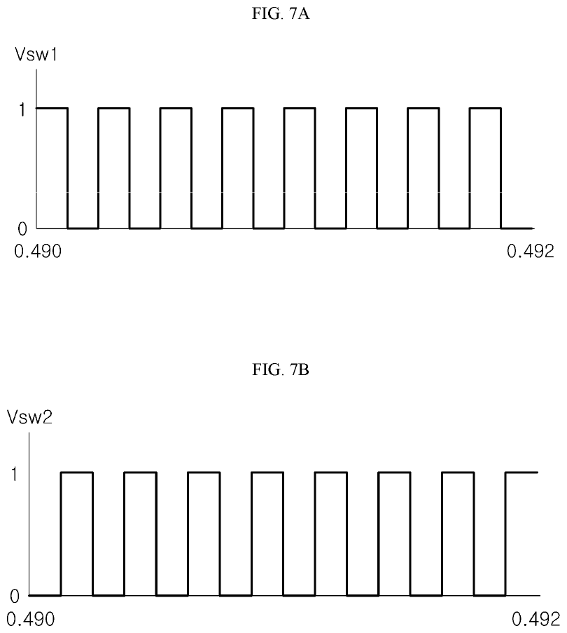

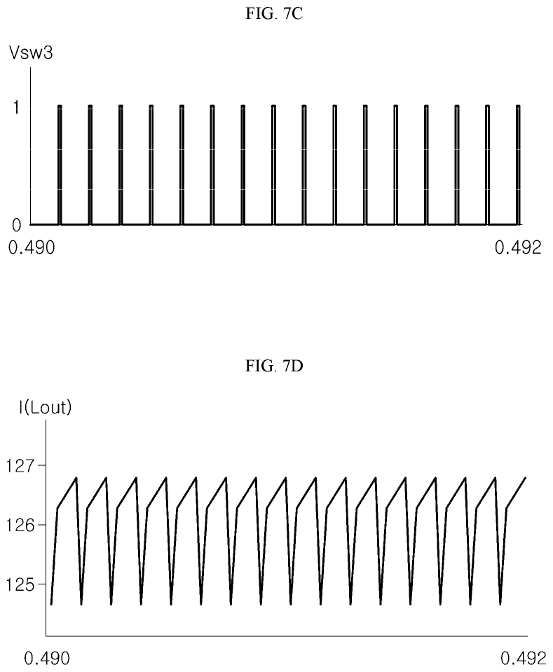

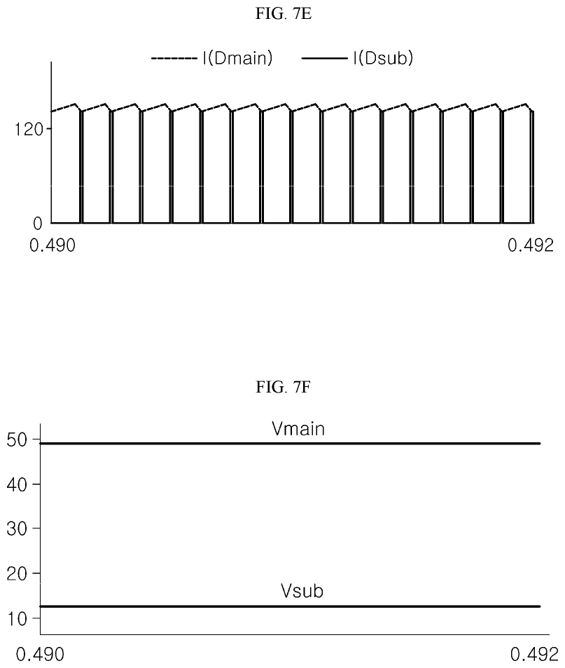

FIG. 5 illustrates an example of a circuit diagram used to perform a simulation on the basis of the charging method according to the present embodiment, and FIG. 6A to FIG. 6F and FIG. 7A to FIG. 7F illustrate results of simulations performed using the circuit diagram of FIG. 5.

Referring to FIG. 5, a DC/DC converter of an on-board charger may be configured as a first circuit 510, and a third switch SW3 for an auxiliary battery and the auxiliary battery Csub may be configured as a second circuit 530, and the main battery Cmain may be configured as a third circuit 550.

FIG. 6A to FIG. 6F illustrate a voltage value and a current value measured when a voltage of 400 V is applied to an input terminal of the first circuit 510, the duty of an output terminal of the first circuit 510 controlled by first and second switches SW1 and SW2 is 0.47, and the duty of the third switch SW3 of the second circuit 530 is 0.03. Specifically, FIG. 6A to FIG. 6C illustrate voltage values measured at the first to third switches SW1, SW2, and SW3, FIG. 6D illustrates an output current of the first circuit 510, FIG. 6E illustrates currents IDmain and IDsub input to a main battery Cmain and the auxiliary battery Csub, and FIG. 6F illustrates voltages Vmain and Vsub measured at the main battery Cmain and the auxiliary battery Csub. As a result of a simulation, a voltage of about 49.45 V and a current of about 123 A are input to the main battery Cmain, and a voltage of about 12.65 V and a current of about 3.75 A are input to the auxiliary battery Csub.

FIG. 7A to FIG. 7F illustrate a voltage value and a current value measured when a voltage of 400 V is applied to the input terminal of the first circuit 510, the duty of the output terminal of the first circuit 510 controlled by the first and second switches SW1 and SW2 is 0.41, and the duty of the third switch SW3 of the second circuit 530 is 0.19. Specifically, FIG. 7A to FIG. 7C illustrate voltage values measured at the first to third switches SW1, SW2, and SW3, FIG. 7D illustrates an output current of the first circuit 510, FIG. 7E illustrates currents Imain and Isub input to the main battery Cmain and the auxiliary battery Csub, and FIG. 7F illustrates voltages Vmain and Vsub measured at the main battery Cmain and the auxiliary battery C sub. As a result of a simulation, a voltage of about 49.72 V and a current of about 116 A are input to the main battery Cmain, and a voltage of about 11.67 V and a current of about 29 A are input to the auxiliary battery Csub.

Referring to FIG. 6A to FIG. 6F and FIG. 7A to FIG. 7F, the duties of primary switches SW1 and SW2 of the DC/DC converter and the duty of the switch SW3 for the auxiliary battery Csub may be adjusted, thereby simultaneously charging the main battery Cmain and the auxiliary battery Csub. Further, voltage and current values supplied to the main battery Cmain and the auxiliary battery Csub may be set to various conditions, thereby charging the main battery Cmain and the auxiliary battery Csub.

The battery charging method according to the embodiment of FIG. 3 has a lower frequency of turning on/off the switches than that of the battery charging method according to the embodiment of FIG. 4, thus having higher overall system efficiency. However, the battery charging method according to the embodiment of FIG. 3 is unfavorable to control an output terminal of the OBC 230 in real time when the load of the second battery 290 is rapidly changed in a situation where the voltage of the second battery 290 is low. On the other hand, the embodiment of FIG. 4 charges the first battery 250 and the second battery 290 in real time, thus being easier to respond to a load change.

Therefore, when the embodiment of FIG. 3 and the embodiment of FIG. 4 are combined, the embodiment of FIG. 4 may be used when the voltage of the second battery 290 is low and thus a response to an instantaneous load change is required, and the embodiment of FIG. 3 may be used when the voltage of the second battery 290 is relatively high and thus a response to an instantaneous load change is not required. Hereinafter, a new battery charging method in which the embodiment of FIG. 3 and the embodiment of FIG. 4 are combined will be described.

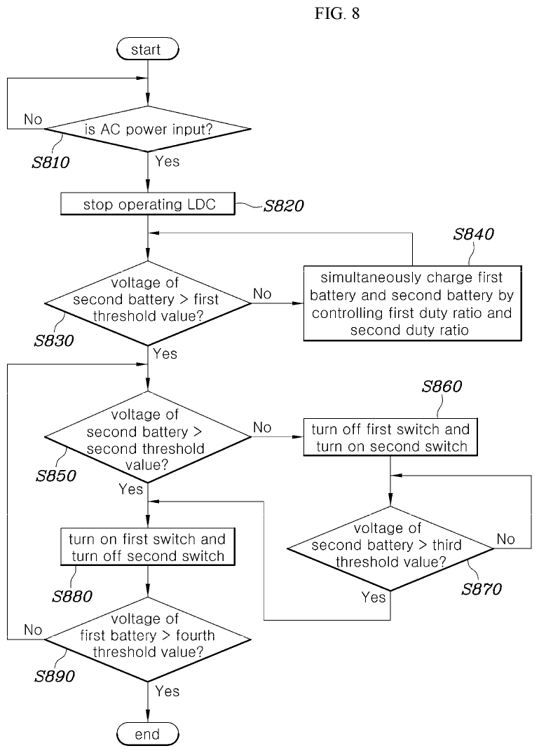

FIG. 8 is a flowchart illustrating a vehicle battery charging method according to still another embodiment of the present disclosure.

Referring to FIG. 8, the vehicle battery charging system monitors whether power from the AC power source 210 is input to the OBC 230 (S810), and stops operating the LDC 270 when the power from the AC power source 210 is input (S820).

The controller 295 determines whether the voltage of the second battery 290 exceeds a first threshold value (S830), and simultaneously charges the first battery 250 and the second battery 290 by controlling a first duty ratio, which is the duty ratio of the at least one switch connected to the input terminal of the primary coil of the DC/DC converter 233, and a second duty ratio, which is a duty ratio between the first switch 240 and the second switch 280 (S840) when the voltage of the second battery does not exceed the first threshold value.

The first switch 240 and the second switch 280 may be alternately turned on/off, and thus the sum of the duty ratio of the first switch 240 and the duty ratio of the second switch 280 may be 1.

The first threshold value may be variously set according to a system configuration. For example, the first threshold value may be set to 12.8 V.

As a result of determination in operation S830, when the voltage of the second battery 290 exceeds the first threshold value, the controller 295 determines whether the voltage of the second battery 290 exceeds a second threshold value (S850), and turns off the first switch and turns on the second switch (S860) when the voltage of the second battery 290 does not exceed the second threshold value.

The second threshold value may be greater than the first threshold value.

The second threshold value may be variously set according to a system configuration. For example, the second threshold value may be set to 13.9 V.

Operations S850 and S860 are for determining whether the state of charge (SOC) of the second battery 290 is sufficient, and for blocking charging of the first battery 250 by the OBC 230 and charging the second battery 290 when the SOC of the second battery 290 is not sufficient.

After operation S860 is performed, the controller 295 determines whether the voltage of the second battery 290 exceeds a third threshold value (S870), and turns on the first switch and turns off the second switch (S880) when the voltage of the second battery 290 exceeds the third threshold value.

The third threshold value may be greater than the second threshold value.

The third threshold value may be variously set according to a system configuration. For example, the third threshold value may be set to 15.1 V.

As a result of determination in operation S870, when the voltage of the second battery 290 does not exceed the third threshold value, the controller 295 controls the second battery 290 to be continuously charged until the voltage of the second battery 290 exceeds the third threshold value.

As a result of determination in operation S850, when the voltage of the second battery 290 exceeds the second threshold value, the controller 295 turns on the first switch and turns off the second switch (S880).

The controller 295 determines whether the voltage of the first battery 250 exceeds a fourth threshold value (S890), and terminates charging the battery when the voltage of the first battery 250 exceeds the fourth threshold value.

The fourth threshold value may be a threshold voltage for determining whether the first battery 250 is fully charged. For example, the fourth threshold value may be 50 V.

As a result of determination in operation S890, when the voltage of the first battery 250 does not exceed the fourth threshold value, the controller 295 performs operation S850 again, and performs a subsequent operation according to the result of the determination in operation S850.

An operation of charging the first battery 250 by turning on the first switch 240 and turning off the second switch 280 may be defined as a first charging mode, and an operation of charging the second battery 290 by turning off the first switch 240 and turning on the second switch 280 may be defined as a second charging mode. Further, an operation of simultaneously charging the first battery 250 and the second battery 290 by adjusting the duty value of the first switch 240 or the second switch 280 may be defined as a third charging mode.

Therefore, according to the present embodiment, in an initial stage of charging, the third charging mode of simultaneously charging the first battery 250 and the second battery 290 may be performed, and after the voltage of the second battery is charged to a certain level or higher, the first or second charging mode of selectively charging the first or second battery according to a result of comparing the voltage of the first or second battery with each threshold value may operate.

According to the foregoing embodiments of the present disclosure, a switch or a relay may be added to an output terminal of an existing OBC circuit, thereby charging a main battery and an auxiliary battery only with an OBC without operating an LDC when performing a slow charging operation of an eco-friendly vehicle using a 48-V battery voltage as a main battery

Further, the auxiliary battery may be charged without using the LDC, thereby improving system charging efficiency and reducing a charging time.

Moreover, the auxiliary battery may be charged with higher output power and efficiency than when using a conventional LDC.

In addition, energy efficiency of the vehicle may be improved, and a charging cost of the eco-friendly vehicle may be reduced.

What is claimed is:

1. A battery charging method of a battery charging system comprising an on-board charger to convert an AC voltage from an outside into a DC voltage, a first battery, and a second battery having a lower rated voltage than that of the first battery, the battery charging method comprising:
operating a first charging mode of turning on a first switch between the on-board charger and the first battery and turning off a second switch between the on-board charger and the second battery when a voltage of the second battery exceeds a first threshold value; and
operating a second charging mode of turning off the first switch and turning on the second switch when the voltage of the second battery does not exceed the first threshold value.

2. The battery charging method of claim 1, wherein the operating of the second charging mode comprises:
determining whether the voltage of the second battery exceeds a second threshold value; and
switching the second charging mode to the first charging mode when the voltage of the second battery exceeds the second threshold value.

3. The battery charging method of claim 2, wherein the operating of the second charging mode further comprises maintaining the second charging mode when the voltage of the second battery does not exceed the second threshold value.

4. The battery charging method of claim 1, wherein the operating of the first charging mode comprises:
determining whether a voltage of the first battery exceeds a third threshold value; and
terminating charging when the voltage of the first battery exceeds the third threshold value.

5. The battery charging method of claim 4, wherein the operating of the first charging mode further comprises:
determining whether the voltage of the second battery exceeds the first threshold value when the voltage of the first battery does not exceed the third threshold value; and
switching to the first charging mode or maintaining the second charging mode according to a result of comparing the voltage of the second battery with the first threshold value.

6. The battery charging method of claim 2, further comprising, before determining whether the voltage of the second battery exceeds the first threshold value:
determining whether the voltage of the second battery exceeds a fourth threshold value; and
operating a third charging mode of simultaneously charging the first battery and the second battery when the voltage of the second battery does not exceed the fourth threshold value.

7. The battery charging method of claim 6, wherein, in the third charging mode, the first battery and the second battery are simultaneously charged by controlling a first duty ratio, which is a duty ratio of a primary switch of a DC converter of the on-board charger, and a second duty ratio, which is a duty ratio between the first switch and the second switch.

8. The battery charging method of claim 7, further comprising:
determining whether the voltage of the second battery exceeds the first threshold value when the voltage of the second battery exceeds the fourth threshold value; and
operating the first charging mode or the second charging mode according to a result of comparing the voltage of the second battery with the first threshold value.

9. The battery charging method of claim 1, wherein the first battery and the second battery mutually share earthing.

10. The battery charging method of claim 6, wherein the second threshold value is greater than the first threshold value, and the fourth threshold value is smaller than the first threshold value.

11. A battery charging system comprising:
an on-board charger configured to convert an AC voltage from an outside into a DC voltage;
a first battery;
a second battery having a lower rated voltage than that of the first battery;
a first switch between the on-board charger and the first battery;
a second switch between the on-board charger and the second battery; and
a controller configured to operate a first charging mode of turning on the first switch and turning off the second switch when a voltage of the second battery exceeds a first threshold value and to operate a second charging mode of turning off the first switch and turning on the second switch when the voltage of the second battery does not exceed the first threshold value.

12. The battery charging system of claim 11, wherein, in the second charging mode, the controller determines whether the voltage of the second battery exceeds a second threshold value, and switches to the first charging mode when the voltage of the second battery exceeds the second threshold value.

13. The battery charging system of claim 12, wherein, in the second charging mode, the controller maintains the second charging mode when the voltage of the second battery does not exceed the second threshold value.

14. The battery charging system of claim 11, wherein, in the first charging mode, the controller determines whether a voltage of the first battery exceeds a third threshold value, and terminates charging when the voltage of the first battery exceeds the third threshold value.

15. The battery charging system of claim 14, wherein, in the first charging mode, the controller determines whether the voltage of the second battery exceeds the first threshold value when the voltage of the first battery does not exceed the third threshold value, and switches to the first charging mode or maintaining the second charging mode according to a result of comparing the voltage of the second battery with the first threshold value.

16. The battery charging system of claim 12, wherein, before determining whether the voltage of the second battery exceeds the first threshold value, the controller determines whether the voltage of the second battery exceeds a fourth threshold value, and operates a third charging mode of simultaneously charging the first battery and the second battery when the voltage of the second battery does not exceed the fourth threshold value.

17. The battery charging system of claim 16, wherein, in the third charging mode, the controller simultaneously charges the first battery and the second battery by controlling a first duty ratio, which is a duty ratio of a primary switch of a DC converter of the on-board charger, and a second duty ratio, which is a duty ratio between the first switch and the second switch.

18. The battery charging system of claim 16, wherein the controller determines whether the voltage of the second battery exceeds the first threshold value when the voltage of the second battery exceeds the fourth threshold value, and operates the first charging mode or the second charging mode according to a result of comparing the voltage of the second battery with the first threshold value.

19. The battery charging system of claim 11, wherein the first battery and the second battery mutually share earthing.

20. The battery charging system of claim 16, wherein the second threshold value is greater than the first threshold value, and the fourth threshold value is smaller than the first threshold value.
